(19) United States
(12) Patent Application Publication
(10) Pub. No.: US 2010/0294537 A1
(43) Pub. Date: Nov. 25, 2010

(54) METHOD OF PRODUCING AN ALUMINIUM WIRE COVERED WITH A COPPER LAYER, AND WIRE OBTAINED

(75) Inventor: Roel Hellemans, Montiron (FR)

Correspondence Address: Perman & Green, LLP, 99 Hawley Lane, Stratford, CT, 06614, US

(73) Assignee: RH INNOVATION, Montiron (FR)

(21) Appl. No.: 12/305,139

(22) PCT Filed: Jun. 21, 2007
(86) PCT No.: PCT/EP2007/056194

§ 371 Date: May 11, 2009

(30) Foreign Application Priority Data
Jun. 21, 2006 (FR) 06 52568

(51) Int. Cl. H01B 5/00

(52) U.S. Cl. 174/126.2

(57) ABSTRACT

To produce an aluminum wire covered with copper, capable of retaining its original electrical and mechanical properties when used in environments in which the temperatures exceed 150° C., the wire is produced by a method during which a material foreign to copper and to aluminum is introduced in a small amount at the interface between the aluminum core and the copper layer. The material has the effect of retarding the precipitation of copper in the aluminum and the growth of Guinier-Preston zones. The wire is produced by a known method of reducing the diameter of a composite bar and the foreign material is introduced into the interface between the copper and the aluminum during production of the composite bar so as to be present in trace amounts after reduction of the diameter.

### CROSS-REFERENCE TO RELATED APPLICATIONS

This application is the National Stage of International Application No. PCT/EP2007/056194 International Filing Date, Jun. 21, 2007, which designated the United States of America, and which International Application was published under PCT Article 21 (2) as WO Publication No. WO2007/147872 A2 and which claims priority from French Application No. 06 52568, filed on Jun. 21, 2006, the disclosures of which are incorporated herein by reference in their entireties.

### BACKGROUND

1. Field

The disclosed embodiments generally relate to the field of wire made of electrically conductive material to make electric cables.

More specifically, the disclosed embodiments relate to the production of wire with an aluminum core protected by a layer of copper on its exterior surfaces.

2. Brief Description of Related Developments

Except for special applications, for example air-transport cables for high-voltage electricity, most electrical cables use copper, or a copper-based alloy, to make the conductive part of the cable.

Copper is an excellent conductor of electricity, is ductile when pure or in certain alloys and is relatively resistant in a mechanical sense, which explains its general use in these applications.

Because of copper's weight, which is unfavorable for certain uses and its relatively high cost, other solutions are used to produce electrical cables.

Light weight and low cost, aluminum has been considered a substitute for copper for many years in the production of electrical conductive wire, despite the fact that it is slightly less favorable in terms of electrical resistance than copper in general.

Since aluminum is sensitive to corrosion, it is often necessary to protect aluminum wire from the outside environment by covering the surface of the wire with a layer that serves as a barrier and is tightly bonded to the aluminum in the wire to limit the risks of oxidation.

Thus, most aluminum-based wire 1 has an aluminum conductive core 2 or an aluminum-based alloy covered with a surface barrier 3 made of a layer of a metal that can adhere to the surface of the core.

The metals most often used for this surface barrier are nickel, Ni, copper, Cu, or an alloy with these metals as a base.

Although nickel has excellent resistance to oxidation, its use is reserved for applications whose cost is not an essential criterion. For economic reasons, copper is often used as the metal for the surface barrier.

Electric wires are generally made by drawing a bar of metal according to a more or less elaborate process based on the quality desired.

In successive wire-drawing and annealing steps, a bar 22 mm in diameter can, for example, be lengthened by a factor of more than 12,000 to yield a wire with a diameter less than 200 μm.

To make an aluminum wire covered with a layer of copper, this general process is applied to a bar of aluminum 21 covered with a sheet of copper 31. The thickness of the copper sheet is chosen in relation to the diameter of the bar in the ratio of the thickness desired on the finished wire compared to the diameter of the aluminum core.

Different methods are known for covering the core with the sheet of copper. One method used consists of rolling a sheet of copper 31 with the desired thickness around the core 2 and of soldering two edges of the sheet thus plated to the core.

The composite bar 11, including the aluminum core and the copper sheet wound around it, is then put through a process to reduce its diameter by drawing to yield an aluminum wire 1 having a copper protective barrier on its surface.

To ensure good cohesion between the copper and the aluminum, the known methods try to produce an interface between the bar and the copper sheet that is as free of impurities as possible.

The surfaces of the bar 22 and the copper sheet 32 that must be placed in contact are normally carefully prepared and pickled, and they are often assembled in a neutral, clean atmosphere to prevent the formation of oxides and dust deposits at the interface between the two materials.

This process makes it possible to produce copper-covered aluminum conductive wire as fine as 200 μm in diameter that is used in the manufacture of electric cables that have a plurality of wires that are more flexible and lighter than cables made with copper wire.

However, despite the precautions taken during the preparation of the bar that must be drawn to make a wire, frequently the wires break during use due to the effect of mechanical stress, particularly in a vibratory environment.

Analysis of these ruptures shows that they are most often due to a transformation of the microstructure of the aluminum linked to the migration of copper atoms into the aluminum.

The copper atoms come together in the aluminum matrix to form precipitations, phenomena that are well known in aluminum alloys containing copper which translates into disorder in the atomic structure of the aluminum. In the following text, these precipitations are designated GP zones, which refers to the discoverers of these phenomena, André Guinier and George Dawson Preston.

These GP zones have the effect of increasing the electrical resistance and reducing the mechanical resistance of the wire.

When the temperature increases, the growth of the Guinier-Preston zones accelerates, which limits the possibility of using such wire in places where the temperature may exceed 150° C.

This phenomenon also complicates the manufacture of the wire, whose production process includes annealing phases, generally around 200° C., which are impossible to avoid.

### SUMMARY

To solve the problems encountered with copper-covered aluminum wire, particularly at usage temperatures above 150° C., the disclosed embodiments are directed to, contrary to the search for maximum purity recommended when using the known manufacturing processes, introducing impurities at the interface between the aluminum and the copper.

Thus, the process of producing a wire with an aluminum core covered with a layer of copper includes the steps of:
making a bar of aluminum or an aluminum-based alloy;
covering the aluminum bar with a sheet of copper or a copper-based alloy to form a composite bar;
depositing beforehand a small quantity of a material called a GP retardant on a surface at the interface between the aluminum bar and the copper sheet that can retard the precipitation of copper in aluminum in formations called GP zones.
reduce, by a known process, the diameter of the composite bar to form the copper-covered aluminum wire.

The GP-retardant material can be deposited by any process that makes it possible to control the quantity of GP retardant material introduced at the interface, like for example a mechanical deposition process, ion implantation, surface diffusion, electrolytic diffusion or vapor phase deposition.

In order to be present only in trace amounts in the wire at the aluminum-copper interface, the GP retardant material is deposited in a quantity such that the average theoretical thickness of said GP retardant material obtained in the wire after reducing the diameter is less than the thickness of a monatomic layer of the GP retardant material.

The GP retardant material can be deposited on the surface of the aluminum bar or on the face of the copper sheet before the copper sheet is plated to the aluminum bar to form the composite bar whose diameter will be reduced to produce the wire.

When the GP retardant material deposited on one face of the copper sheet is capable of ruining the quality of the junction between the edges of the sheet that must be soldered to envelop the aluminum bar, the areas near the edges are left with no deposit of GP retardant material.

The GP retardant material, which is different from the aluminum and the copper, is sought from among materials that have an effect on the precipitation of GP zones, can include at least one metal, such as lead, tin, magnesium or iron and can include at least one non-metallic element, such as carbon, gallium or germanium.

The disclosed embodiments are also directed to a wire with a copper-covered aluminum core that has at the aluminum-copper interface or near that interface, traces of a material that retards the precipitation of the copper atoms in the aluminum. The quantity of material that retards the precipitation of the copper atoms in the aluminum corresponds to an average theoretical layer thickness, mounted on the surface of the interface between the aluminum core and the copper layer, less than a monatomic layer of said retardant material.

The disclosed embodiments are also directed to an electric cable produced by assembling wires produced according to the disclosed embodiments, particularly an electric cable that is to be used up to temperatures on the order of 200° C.

### BRIEF DESCRIPTION OF THE DRAWINGS

A detailed description of an aspect of the disclosed embodiments is given with reference to the figures, which show:

FIG. 1: a copper-covered aluminum wire obtained by reducing the diameter of a composite bar;

FIG. 2: the elements of a composite bar before they are assembled;

FIG. 3: the composite bar assembled before reducing the diameter.

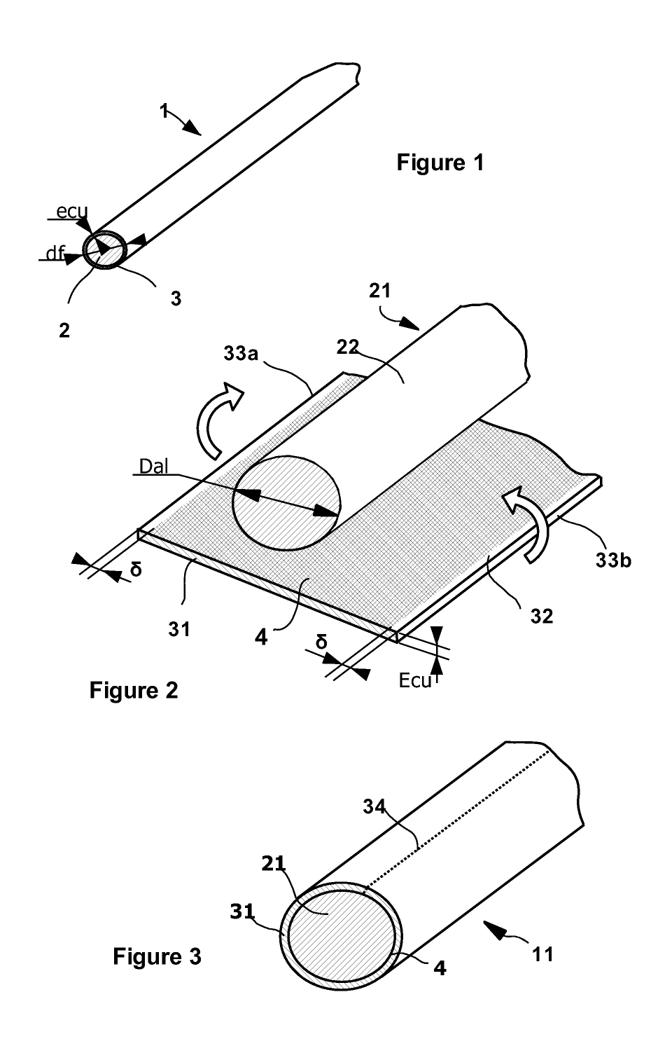

### DETAILED DESCRIPTION OF THE DISCLOSED EMBODIMENTS

An electric wire 1 with a diameter df having an aluminum or aluminum-based core 2, and an exterior covering made of copper with a thickness ecu, or of a copper-based alloy, is produced by reducing the diameter of a composite bar 11.

The composite bar 11 is obtained from an aluminum bar 21 with a diameter Dal, typically a bar 25 mm in diameter and approximately 2 meters in length; these dimensions are a function of the means of production and shaping that are used for the successive steps in producing the wire, around which is placed a copper covering 31 with a thickness Ecu.

The thickness Ecu of the copper covering 31 is determined as a function of the final thickness sought ecu for the copper covering on the wire and depends on the ratio between the diameter of the wire df being produced and the diameter of the bar 11 whose diameter is to be reduced.

If Db is the diameter of the composite bar 11 (before reducing its diameter) and df the diameter of the wire (after its diameter is reduced), in the known way:

Ecu/ecu=Db/df

or ECU=ecu×Dal/(df−2×ecu)

The choice of ecu is dictated by mechanical considerations. Since the purpose of the copper layer 3 on the outside of the wire 1 is to protect the aluminum core 2 from the environment, ecu is advantageously chosen with as low a value as possible, provided that this copper layer has no discontinuity after the application of the process for reducing the diameter.

For example, for a generally sufficient thickness ecu of 5 μm and a reduction in the diameter in a ratio of 110, the value of Ecu is set at 0.55 mm.

Before placing the copper plate 31 on the aluminum bar 21, a foreign material 4 is deposited in small quantities on the surface of the interface between the copper and the aluminum, either on a surface 32 of the copper plate 31, or on the surface 22 of the aluminum bar 21, or on both surfaces.

The foreign material 4 is a material different from aluminum and copper, which has the effect of significantly retarding the migration of the copper atoms into the aluminum and/or of retarding the growth of GP zones, sources of dislocation of grains of aluminum.

The foreign material 4, called a GP retardant material, does not have as its objective to form a mechanical barrier between the copper of the plate 31 and the aluminum of the bar 21. It is deposited in a small enough quantity not to significantly modify the mechanical and electrical properties of the aluminum and the copper and to be found, after the diameter is reduced, only in trace amounts or impurities on the surface or near the surface of the aluminum core 2 of the wire 1.

Advantageously, the GP retardant material 4 is deposited in a quantity such that it represents, after the diameter of the composite bar 11 is reduced to the diameter of the wire 1, a theoretical average thickness less than the diameter of the atoms of said GP retardant material and such that it does not substantially reduce the contact surface between the copper and the aluminum.

For example, when the reduction in diameter is 100, the GP retardant material 4 will be deposited on an average thickness of approximately 100 times the atomic diameter of said material or less, i.e., in practice an average thickness of several dozens of nanometers.

The GP retardant material is deposited in the form of a layer that is approximately continuous and a thickness that is approximately constant or is deposited in a more or less regular pattern, for example a network of lines resulting in a homogeneous distribution of the atoms of the GP retardant material after the diameter is reduced.

Advantageously, the copper plate 31 that must be applied to the aluminum bar 21 is plane in a first step, as presented in FIG. 2, and has edges 33a, 33b approximately parallel the length of said plate corresponding to the length of said aluminum bar, and the GP retardant material 4 is deposited on the face 32 of said plate that must be in contact with the aluminum bar 21.

The copper plate 31 is then applied to the aluminum bar 21, face 32 on which is deposited the GP retardant material 4 against the surface 22 of said aluminum bar, so that the edges 33a, 33b of the copper plate 31 are approximately juxtaposed along a generating line of the bar 11, then the juxtaposed edges of the plate are soldered 34 together, for example by means of a laser.

In another aspect of the disclosed embodiments, the GP retardant material 4 is deposited on the surface 22 of the aluminum bar 21 before it is covered with a copper plate 31.

Deposition on the copper plate 31 or on the aluminum bar 21 is done by mechanical means, projection or serigraphy, for example, or by an electrolytic process, ion implantation, surface diffusion or vapor phase deposition, according to the process best suited to the GP retardant material 4 used.

When the GP retardant material 4 is deposited on the copper plate 31 and said material could degrade the quality of the soldered connection 34 between the two edges 33a, 33b of the copper plate, zones 5 on the surface of said copper plate, near the edges that must be soldered, are preferably not covered with the GP retardant material 4.

The composite bar 11 comprised of an aluminum bar 21, a layer of a small quantity of GP retardant material 4 and a copper plate 11 around the aluminum bar is put through a treatment to reduce the diameter by a known process, for example by drawing or wire-drawing.

The GP retardant material 4, which cannot be aluminum or copper, is a metallic or non-metallic material.

Advantageously, the GP retardant material is chosen from the family of metals that includes lead (Pb), tin (Sn), magnesium (Mg) or iron (Fe), or is chosen from a family of non-metallic materials, among them carbon (C), gallium (Ga) or germanium (Ge). This list of materials is not limiting and other materials can be evaluated and selected, experimentally, for example, based on their effectiveness in retarding the growth of GP zones.

The wire 1 obtained after reducing the diameter of the composite bar 11 has an aluminum core 2 on the surface or near the surface due to the atomic migration, in which a GP retardant material 4 is found in trace amounts, and it has a continuous copper exterior layer 3.

The wires obtained in this way, whose diameter may, if necessary, be less than one tenth of a millimeter, are advantageously assembled to form an electric cable that is both flexible and resistant.

Due to the presence of the GP retardant material in the wire manufacturing process, it is possible to do annealing during the operations to reduce the diameter without the risk of creating GP zones and hence obtaining a greater reduction in the diameter of the copper-covered aluminum wire than with the traditional processes or simplifying the existing processes.

In addition, the wire produced by this process and the electric cables produced with such wire are capable of working in an environment in which the temperature may reach 200° C. or more without fear of growth of GP zones, which embrittle wires with an aluminum core plated with conventional copper and render them unfit for use in environments where the temperature exceeds approximately 150° C.

What is claimed is:

1. A method of producing a wire with a core made of aluminum covered with a layer of copper comprising:
producing a bar made of aluminum or an aluminum-based alloy,
covering said aluminum bar with a sheet of copper or a copper-based alloy to form a composite bar,
reducing the diameter of the composite bar to form the wire made of copper-covered aluminum,
wherein a material capable of retarding the precipitation of copper in aluminum in formations called GP zones, said material being called a GP retardant, different from aluminum and copper, is deposited in small quantities on a surface at the interface between the aluminum bar and the copper sheet.

2. The method of claim 1 further comprising that the GP retardant material is deposited by a process of mechanical deposition, ion implantation, surface diffusion, electrolytic diffusion or vapor phase deposition.

3. The method of claim 1 further comprising that the GP retardant material is deposited in quantities such that the average theoretical thickness of said GP retardant material obtained in the wire after reducing the diameter is less than the thickness of a monatomic layer of the GP retardant material.

4. The method of claim 1 further comprising that the GP retardant material is deposited on the surface of the aluminum bar.

5. The method of claim 1 further comprising that the GP retardant material is deposited on one of the faces of the copper sheet.

6. The method of claim 5 further comprising that the GP retardant material is deposited on one face of the copper sheet leaving zones δ near the edges that must be juxtaposed of said copper sheet without deposition of the GP retardant material.

7. The method of claim 1 wherein the GP retardant material is comprised of at least one metal.

8. The method of claim 7 further comprising that the metal is chosen from among lead, tin, magnesium and iron.

9. The method of claim 1 wherein the GP retardant material comprises at least one non-metallic element.

10. The method of claim 9 further comprising that the non-metallic element is chosen from among carbon, gallium and germanium.

11. A wire with a core made of aluminum covered with a layer of copper, comprising, at the interface between the aluminum and the copper or near that interface, in trace amounts, a material that retards the precipitation of the copper atoms in the aluminum.

12. The wire of claim 11 further comprising that the quantity of material retarding the precipitation of copper atoms in aluminum corresponds to an average theoretical layer thickness, in relation to the surface of the interface between the aluminum core and the copper layer less than a monatomic layer of said retardant material.

13. The wire of claim 11 further comprising that the material that retards the precipitation of copper atoms in aluminum has at least one metal such as lead, tin, magnesium and iron and/or has at least one simple non-metallic body such as carbon, germanium and gallium.

14. An electric cable produced by an assembly of wires in conformity with claim 11.

15. An electric cable according to claim 14 further comprising that the material that retards the precipitation of copper atoms in aluminum makes it possible to use said electric cable up to temperatures of 200° C.
